(19) United States
(12) Patent Application Publication
(10) Pub. No.: US 2017/0127299 A1
(43) Pub. Date: May 4, 2017

(54) RADIO NETWORK NODES AND METHODS FOR UPDATING EXTERNAL CELL INFORMATION

(71) Applicant: Telefonaktiebolaget LM Ericsson (publ), Stockholm (SE)

(72) Inventors: Stefan ENGSTRÖM, Linköping (SE); Tobias AHLSTRÖM, Ljungsbro (SE)

(73) Assignee: Telefonaktiebolaget LM Ericsson (publ), Stockholm (SE)

(21) Appl. No.: 15/317,582

(22) PCT Filed: Jun. 17, 2014
(86) PCT No.: PCT/SE2014/050747

§ 371 Date: Dec. 9, 2016

(51) Int. Cl. H04W 24/02; H04W 48/16

(52) U.S. Cl. CPC H04W 24/02; H04W 48/16

(57) ABSTRACT

A method in a first radio network node for updating external cell information is provided. The external cell information relates to a first cell served by a second radio network node. The first radio network node determines that there is a need to update the external cell information. The first radio network node sends a first message to the second radio network node. The first message comprises a request for data representing information relating to the first cell. The first radio network node receives a second message from the second radio network node. The second message comprises the requested data. The first radio network node updates the external cell information based on the received data.

### TECHNICAL FIELD

Embodiments herein relate to radio network nodes and to methods in the radio network nodes. In particular, embodiments relate to updating external cell information.

### BACKGROUND

Communication devices such as wireless devices are also known as e.g. user equipments (UE), mobile terminals, wireless terminals, and/or mobile stations. Wireless devices are enabled to communicate wirelessly in a cellular communications network or wireless communication system, sometimes also referred to as a cellular radio system or cellular networks. The communication may be performed e.g. between two wireless devices, between a wireless device and a regular telephone and/or between a wireless device and a server via a Radio Access Network (RAN) and possibly one or more core networks, comprised within the cellular communications network.

Wireless devices may further be referred to as mobile telephones, cellular telephones, laptops, tablet computers or surf plates with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another wireless device or a server.

The wireless communications network covers a geographical area which is divided into cell areas, wherein each cell area being served by a radio network node. A cell is the geographical area where radio coverage is provided by the radio network node.

The radio network node may e.g. be a base station such as a Radio Base Station (RBS), eNB, eNodeB, NodeB, B node, or Base Transceiver Station (BTS), depending on the technology and terminology used. The base stations may be of different classes such as e.g. macro eNodeB, home eNodeB or pico base station, based on transmission power and thereby also cell size.

Further, each radio network node may support one or several communication technologies. The radio network nodes communicate over the air interface operating on radio frequencies with the wireless terminals within range of the radio network node. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

Radio network nodes may exchange information between one another. The information may e.g. concern cells served by the radio network nodes. In LTE, eNBs exchange information via an interface referred to as the X2 interface, as described in 3GPP Technical Specification (TS) 36.423, Version 12.1.0. In addition to information relating to one or several cells served by an eNB, information relating to cells neighbouring the served cell or cells may also be exchanged. A first eNB may thus get information about cells served by a second eNB. From the first eNB's point of view, this information is regarded as external cell information. The external cell information may concern the cells served by the second eNB as well as cells neighbouring those cells. External cell information from the second eNB is e.g. received by the first eNB at setup of the X2 interface between the first and the second eNB. The external cell information then stored in the first eNB, since it may become useful later on.

### SUMMARY

It is an object of embodiments herein to enhance the performance in a wireless communications network in which radio network nodes exchange information relating to cells served by the radio network nodes.

According to a first aspect of embodiments herein, the object is achieved by a method in a first radio network node, for updating external cell information. The external cell information relates to a first cell served by a second radio network node. The first radio network node determines that there is a need to update the external cell information. The first radio network node sends a first message to the second radio network node. The first message comprises a request for data representing information relating to the first cell. The first radio network node receives, from the second radio network node, a second message. The second message comprises the requested data. The first radio network node updates the external cell information based on the received data

According to a second aspect of embodiments herein, the object is achieved by a method in a second radio network node, for updating external cell information in a first radio network node. The external cell information relates to a first cell served by the second radio network node. The second radio network node receives a first message from the first radio network node. The first message comprises a request for data representing information relating to the first cell. The second radio network node sends a second message to the first radio network node. The second message comprises the requested data, and is sent for enabling the first radio network node to update the external cell information based on the data.

According to a third aspect of embodiments herein, the object is achieved by a first radio network node, for updating external cell information. The, which external cell information relates to a first cell served by a second radio network node. The first radio network node is configured to determine that there is a need to update the external cell information. The first radio network node is further configured to send a first message to the second radio network node. The first message comprises a request for data representing information relating to the first cell. The first radio network node is further configured to receive a second message from the second radio network node. The second message comprises the requested data. The first radio network node is further configured to update the external cell information based on the received data.

According to a fourth aspect of embodiments herein, the object is achieved by a second radio network node, for updating external cell information in a first radio network node. The external cell information relates to a first cell served by the second radio network node. The second radio network node is configured to receive a first message from the first radio network node. The first message comprises a request for data representing information relating to the first cell. The second radio network node is further configured to send a second message to the first radio network node. The second message comprises the requested data, for enabling the first radio network node to update the external cell information based on the data.

An advantage with embodiments herein is that since the first radio network node is able to determine that it needs external cell information from a second radio network node, and since it is able to request this information when needed, the need to store external cell information, sent to the first radio network node from the second radio network node, without the first radio network node asking for it, is reduced. The solution may be regarded as a pull mechanism, enabling the first radio network node to pull relevant information from the second radio network node when needed.

### BRIEF DESCRIPTION OF THE DRAWINGS

Examples of embodiments herein are described in more detail with reference to attached drawings in which:

FIG. 1 schematically illustrates a wireless communications network.

FIG. 2 schematically illustrates a management system of a wireless communications network.

FIG. 3 schematically illustrates embodiments of a wireless communications network.

FIG. 4 is a flowchart depicting embodiments of a method in a first radio network node.

FIG. 5 is a combined signalling diagram and flowchart illustrating embodiments in a wireless communications network.

FIG. 6 is a flowchart depicting embodiments of a method in a second radio network node.

FIG. 7 is a schematic block diagram illustrating embodiments of a first radio network node.

FIG. 8 is a schematic block diagram illustrating embodiments of a second radio network node.

### DETAILED DESCRIPTION

As part of developing embodiments herein, some problems will first be identified and discussed.

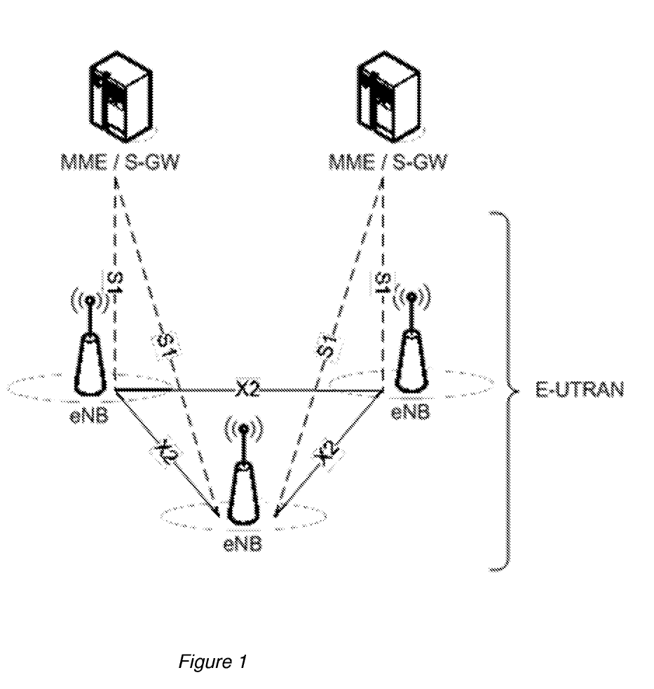

An Evolved packet system (EPS) in which embodiments herein may be implemented is shown in FIG. 1. The EPS comprises a RAN implemented as an Evolved Universal Terrestrial RAN (E-UTRAN) and the Evolved packet core (EPC). The E-UTRAN comprises radio access nodes, eNBs, also referred to as radio network nodes. A Mobility Management Entity (MME) is a control plane node of the EPC. A Serving Gateway (S-GVV) is a user plane node of the EPC. The interface between eNBs is referred to as X2, and the interface between eNB and MME/S-GW is denoted S1. The signaling transport over X2 and S1 may be implemented via Stream Control Transmission Protocol (SCTP).

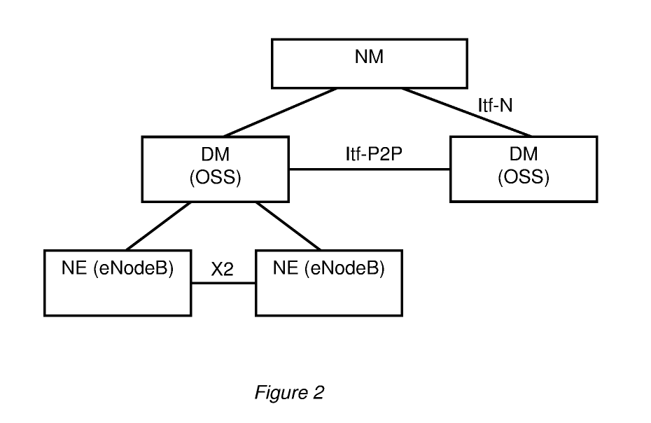

A management system that may be employed in embodiments herein is shown in FIG. 2. Network elements (NE), also referred to as radio access nodes, radio network nodes or eNodeBs, are managed by a domain manager (DM), also referred to as the operation and support system (OSS). A DM may further be managed by a network manager (NM). Two NEs are interfaced by X2, whereas the interface between two DMs is referred to as Itf-P2P. The management system may configure the network elements, as well as receive observations associated to features in the network elements. For example, the DM observes and configures NEs, while the NM observes and configures DMs, as well as NEs via DM.

Radio network nodes, such as eNBs exchange information between one another, such as served cell information. An initiating eNB may initiate the procedure by sending an X2 SETUP REQUEST message to a candidate eNB. The candidate eNB replies with the X2 SETUP RESPONSE message. The initiating eNB then transfers the complete list of its served cells and, if available, a list of supported Globally Unique (GU) Group Ids to the candidate eNB2. The candidate eNB replies with the complete list of its served cells and includes, if available, a list of supported GU Group Ids in the reply.

The initiating eNB may include a Neighbour Information IE in the X2 SETUP REQUEST message. The candidate eNB may also include the Neighbour Information IE in the X2 SETUP RESPONSE message. The Neighbour Information IE comprises E-UTRAN cells that are direct neighbours of cells in the reporting eNB.

If served cells or neighbour cells are changed, the information is updated accordingly in an ENB CONFIGURATION UPDATE message.

An initiating eNB may initiate the procedure by sending an ENB CONFIGURATION UPDATE message to a peer eNB. Such message comprises an appropriate set of up-to-date configuration data, including, but not limited to, the complete lists of added, modified and deleted served cells in the initiating eNB.

The information about the served cells that are sent over the X2 interface between the two eNBs is normally stored in the receiving eNB, where information about each external cell, i.e. a cell served by a peer eNB, is stored individually. Information on some of the external cells are used by the node for mobility, load management, inter-cell interference co-ordination (ICIC) or by other features, but information for some external cells is not. The trend is to have more and more cells per node, hence in that way increasing the data from other nodes that the node needs to modulate and store, even though only a fraction of the information will be used. Also, in those X2 messages, information about neighbours to the served cells is sent and not only information on served cells. The information about these neighbour cells is also used to a limited extent and some information is never used.

The problem is that a large amount of information is received at the same time, only a fraction will be needed and it cannot be decided upon reception of the information, what part will later be needed. All of the information must be stored by the receiving node, which wastes capacity in the node.

Furthermore, the information on external cells and their neighbour relations is normally mirrored into an Operations and Maintenance (O&M) system and unnecessarily consumes capacity also there.

In LTE, the neighbour information that is not stored can today be retrieved from the neighbour eNB only by triggering a new X2 Setup. The problem with this solution is that all procedures that are ongoing over this X2 interface will be aborted and also that a lot of information, that is of no use, is again transferred, as all served cells with neighbour cell information is included.

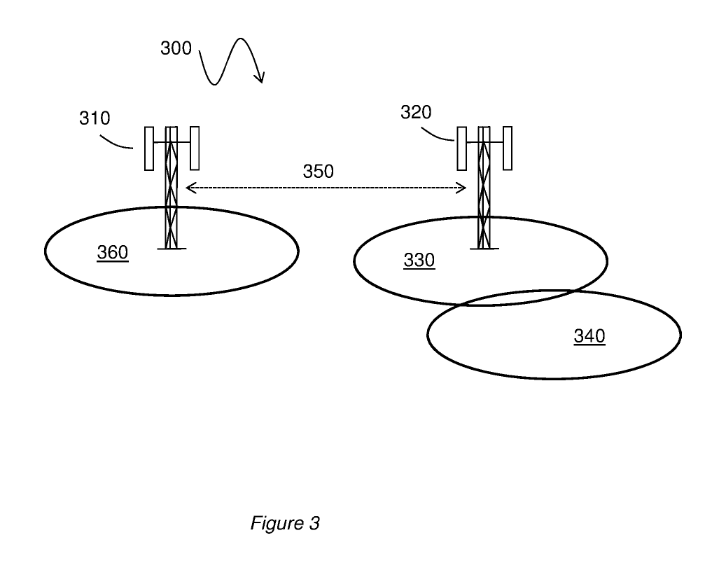

FIG. 3 depicts an example of a wireless communications network 300 in which embodiments herein may be implemented. The wireless communications network 300 may be referred to as a wireless or a cellular network e.g. based on any of 3rd Generation, Universal Mobile Telecommunications System (UMTS), Wideband Code Division Multiple Access (WCDMA), High Speed Packet Access (HSPA) and 4th Generation (4G), Evolved Packet System (EPS), Long Term Evolution (LTE), Long Term Evolution Advanced (LTE-A), or may be referred to as a wireless communication network such as an LTE, WCDMA, Global System for Mobile Communications (GSM) network, any 3GPP cellular network, Worldwide Interoperability for Microwave Access Amax), or any cellular network or system.

The wireless communications network 300 comprises a plurality of network nodes whereof two are depicted in FIG. 3. One of those is a first radio network node 310. The first network radio node 310 may be a transmission point such as a radio base station, for example an eNB, an eNodeB, or an Home Node B, an Home eNode B or any other network node capable to serve a wireless device such as a user equipment or a machine type communication device in a wireless communications network. The first radio network node may also act as a master node to one or more secondary network nodes, where a secondary node also serves a wireless device.

The other network node depicted in FIG. 3 is a second radio network node 320. Like the first radio network node, the second radio network node 320 may be a transmission point such as a radio base station, for example an eNB, an eNodeB, or an Home Node B, an Home eNode B or any other network node capable to serve a wireless device such as a user equipment or a machine type communication device in a wireless communications network. The second radio network node may also act as a master node to one or more secondary network nodes, where a secondary node also serves a wireless device.

The second radio network node 320 serves a first cell 330. The second radio network node 320 thus provides radio coverage to the first cell 330. In FIG. 3, one first cell 330 is depicted. However, there may be a plurality of cells, served by the second radio network node 320.

A second cell 340 neighbours the first cell 330. The second cell 340 may be served by a third radio network node (not shown).

An interface 350 interconnects the first radio network node 310 and the second radio network node 320. The interface 350 may be an X2 interface.

The first radio network node 310 serves a third cell 360. The first radio network node 310 thus provides radio coverage to the third cell 360. In FIG. 3, one third cell 360 is depicted. However, there may be a plurality of cells, served by the first radio network node 310.

The first radio network node may e.g. receive external cell information when the interface between the first radio network node and the second radio network node is setup, e.g. in an X2 SETUP MESSAGE. This information may thus be regarded as “pushed” to the first radio network node. When the first radio network node receives this information, it does not know if the information will be needed later on, or if it will not be needed at all. In current solutions, all of the received external cell information has to be stored in the first radio network node, since it may be needed later on. However, most of the information may not be needed. Storage of the not needed information wastes capacity in the first radio network node and thus reduces the performance of the wireless communications network.

Since embodiments herein provide a possibility to request external cell information when needed, some of the information which is “pushed” to the first radio network node when the first radio network node has not explicitly asked for it may be discarded. Capacity usage of the first radio network node is then improved, and thereby also the performance of the wireless communications network.

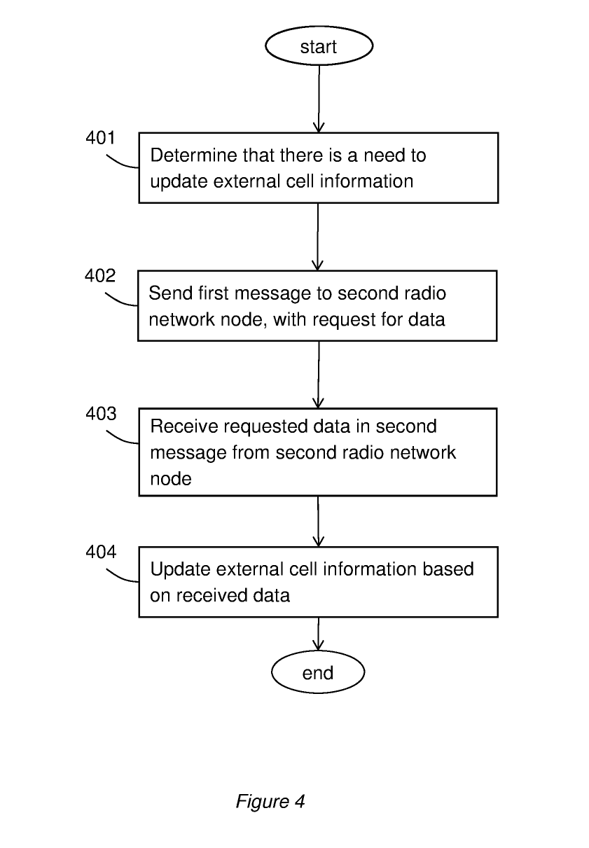

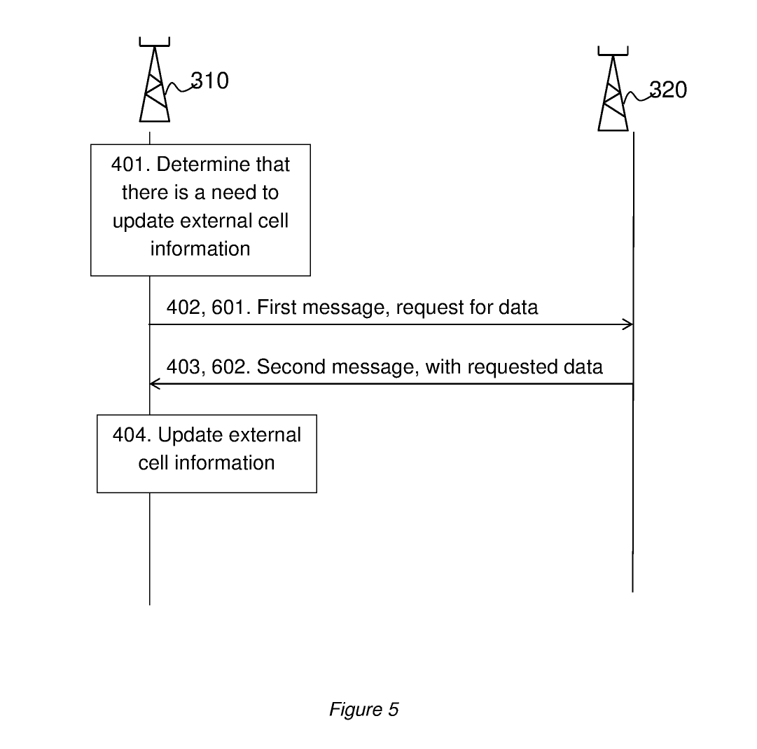

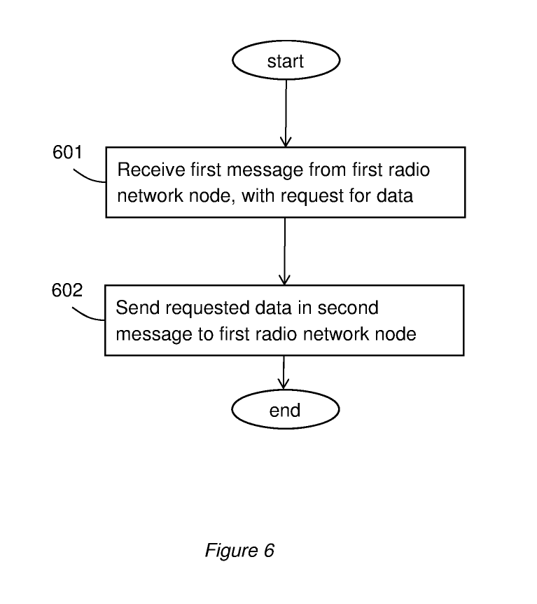

Example embodiments of a method in the first radio network node 310, for updating external cell information, will now be described with reference to a flowchart depicted in FIG. 4. The method comprises the following actions, which actions may be taken in any suitable order. First, the method is described in a general way, here as seen from the first radio network node's 310 point of view, relating to FIG. 4 and FIG. 5. Then, the method will be described as seen from the second radio network node's 320 point of view, relating to FIG. 5 and FIG. 6. FIG. 5 is a combined flow chart and signaling diagram, giving an overview of embodiments of a method according to embodiments herein. The method will then be described in more detail below.

Embodiments herein address scenarios in which the first radio network node 310 is connected to the second radio network node by means of the interface 350.

### Action 401

The first radio network node 310 determines that there is a need to update the external cell information. The external cell information relates to a first cell 330, served by the second radio network node 320.

In some embodiments, the determining is based on a detection of at least one of a Physical Cell Identity (PCI) collision and a PCI confusion. A PCI algorithm may then have to be performed in the first radio network node 310, in order to reallocate a new PCI to the third cell 360. The first network node 310 then needs external cell information relating to the first cell 330 and to a second cell 340, neighboring the first cell 330.

In some embodiments, the determining is based on an addition of a relation between a third cell 360, served by the first radio network node 310, and the first cell 330. The first network node 310 may then need external cell information, which external cell information relates to the first cell 330.

### Action 402

The first radio network node 310 sends, to the second radio network node 320, a first message which first message comprises a request for data representing information relating to the first cell 330. The first radio network node thus triggers the second radio network node to send the requested data. The first message may be represented by an ENB CONFIGURATION REQUEST message, which is described in more detail below. Alternatively, the first message may be represented by an ENB CONFIGURATION UPDATE REQUEST message, which is described in more detail below.

In some embodiments the request for data relating to the first cell 330 comprises an indication of a kind of information requested. The kind of information is then at least one of information relating to the first cell 330 and information relating to at least one second cell 340 neighbouring the first cell. The indication may be represented by a Cell Information Requested Information Element (IE). Information relating to the first cell 330 may be represented by a Served Cell information IE. Information relating to the second cell 340, neighbouring the first cell 330, may be represented by a Neighbour Information IE.

### Action 403

The first radio network node 310 receives, from the second radio network node 320, a second message, which second message comprises the requested data.

In embodiments in which the first message is represented by an ENB CONFIGURATION REQUEST message, the second message may be represented by an ENB CONFIGURATION RESPONSE message, which is described in more detail below.

In embodiments in which the first message is represented by an ENB CONFIGURATION UPDATE REQUEST message, the second message may be represented by an ENB CONFIGURATION UPDATE message. In those embodiments, a previously known message is thus reused for sending the external cell information to the first radio network node 310. The ENB CONFIGURATION UPDATE message is further described below.

### Action 404

Now that the first radio network node 310 has received the data it requested, the first radio network node 310 updates the external cell information based on the received data.

In embodiments in which the need to update the external cell information is due to a PCI confusion and/or a PCI collision, the first radio network node may perform the PCI reallocation mechanism when it has received the data. The data may in those embodiments relate to information regarding the first cell 330 and information regarding a second cell 340.

A method will now be described from a perspective of the second radio network node 320. Thus, embodiments of a method in a second radio network node 320, for updating external cell information in a first radio network node 310 will be described with reference to a flowchart depicted in FIG. 6, and to the combined flow chart and signaling diagram depicted in FIG. 5. The external cell information relates to a first cell 330, served by the second radio network node 320. The method comprises the following actions, which actions may be taken in any suitable order.

### Action 601

The second radio network node 320 receives a first message from the first radio network node 310. The first message comprises a request for data representing information relating to the first cell 330.

In some embodiments the request for data relating to the first cell 330 comprises an indication of a kind of information requested. The kind of information is then at least one of information relating to the first cell 330 and information relating to at least one second cell 340 neighbouring the first cell. The indication may be represented by a Cell Information Requested Information Element (IE). Information relating to the first cell 330 may be represented by a Served Cell information IE. Information relating to the second cell 340, neighbouring the first cell 330, may be represented by a Neighbour Information IE.

### Action 602

The second radio network node 320 sends a second message to the first radio network node 310. The second message comprises the requested data, for enabling the first radio network node 310 to update the external cell information based on the data.

Exemplary embodiments of methods described in a general way above will now be described in more detail. The description below may refer to any embodiment above.

When the first radio network node 310 detects that it needs external cell information from the second radio network node 320, it may trigger the second radio network node 320 to send the needed information. The external cell information may be information that was discarded by the first radio network node 310 when it first received it, e.g. in an X2 setup procedure. The detection relates to action 401 described above.

To receive the external cell information, the first radio network node 310 needs to trigger the second radio network node to send the needed information.

The first message might be formulated to cover the need for information, such as a Cell Global Identifier (CGI) relating to specified cells or all cells served by the second radio network node 320.

This may be achieved with a new procedure in which an ENB CONFIGURATION REQUEST message is sent as a first message to the second radio network node. This relates to actions 402 and 601 described above. The first message might be formulated to cover the need for information, such as a Cell Global Identifier (CGI) relating to specified cells or all cells served by the second radio network node 320. The first cell 330 may accordingly be one or several cells, as indicated in the first message.

Table 1 depicts a possible format of an ENB CONFIGURATION REQUEST message.

TABLE 1
Possible format of a new ENB CONFIGURATION
REQUEST message

| | | | IE type | |
|---|---|---|---|---|
| IE/Group | | | and | Semantics |
| Name | Presence | Range | reference | description |
| Message | M | | 9.2.13 | |
| Type | | | | |
| Requsted | | 0 . . . | | List of cells |
| Cells to | | <maxCellineNB> | | for which |
| Update | | | | information is |
| | | | | requested |
| >ECGI | M | | ECGI | E-UTRAN |
| | | | 9.2.14 | Cell Global |
| | | | | Identifier of |
| | | | | the cell |
| >Cell | M | | BIT | |
| Information | | | STRING | |
| Requested | | | | |

Alternatively, the first message may be an ENB CONFIGURATION UPDATE REQUEST message, which is used to trigger the existing function for ENB Configuration Update. Sending of the ENB CONFIGURATION UPDATE REQUEST message also relates to actions 402 and 601 described above. The first message might be formulated to cover the need for information, such as a Cell Global Identifier (CGI) relating to specified cells or all cells served by the second radio network node 320. The first cell 330 may accordingly be one or several cells, as indicated in the first message.

Table 2 depicts a possible format of an ENB CONFURATION REQUEST message.

TABLE 2
Possible format of a new ENB CONFIGURATION
UPDATE REQUEST message.

| | | | IE type | |
|---|---|---|---|---|
| IE/Group | | | and | Semantics |
| Name | Presence | Range | reference | description |
| Message | M | | 9.2.13 | |
| Type | | | | |
| Requested | | 0 . . . | | List of cells |
| Cells to | | <maxCellineNB> | | for which |
| Update | | | | information is |
| | | | | requested |
| >ECGI | M | | ECGI | E-UTRAN Cell |
| | | | 9.2.14 | Global |
| | | | | Identifier of |
| | | | | the cell |
| >Cell | M | | BIT | |
| Information | | | STRING | |
| Requested | | | | |

In embodiments in which the first radio network node triggers a new procedure by means of sending the ENB CONFIGURATION REQUEST message as a first message to the second radio network node, the second radio network node may responds by means of sending a second message represented by an ENB CONFIGURATION RESPONSE message. This relates to actions 403 and 602 described above. Table 3 depicts a possible format of an ENB CONFIGURATION RESPONSE message.

TABLE 3
Possible format of a new ENB CONFIGURATION RESPONSE message

| | | | IE type | |
|---|---|---|---|---|
| | | | and | Semantics |
| IE/Group Name | Presence | Range | reference | description |
| Message Type | M | | 9.2.13 | |
| Served Cells To | | 0 . . . <maxCellineNB> | | List of cells served by |
| Update | | | | the eNB, for which |
| | | | | information is updated |
| >Served Cell | M | | 9.2.8 | |
| Information | | | | |
| >Neighbour | | 0 . . . <maxnoofNeighbours> | | |
| Information | | | | |
| >>ECGI | M | | ECGI | E-UTRAN Cell Global |
| | | | 9.2.14 | Identifier of the |
| | | | | neighbour cell |
| >>PCI | M | | INTEGER | Physical Cell Identifier |
| | | | (0 . . . 503, . . . ) | of the neighbour cell |
| >>EARFCN | M | | 9.2.26 | DL EARFCN for FDD or |
| | | | | EARFCN for TDD |
| >>TAC | O | | OCTET | Tracking Area Code |
| | | | STRING | |
| | | | (2) | |
| >Deactivation | O | | ENUMERATED | Indicates that the |
| Indication | | | (deactivated, . . . ) | concerned cell is |
| | | | | switched off for energy |
| | | | | saving reasons |

In embodiments in which the first radio network node triggers an existing procedure by means of sending the ENB CONFIGURATION UPDATE REQUEST message as a first message to the second radio network node, the second radio network node may responds by means of sending a second message represented by an ENB CONFIGURATION UPDATE message. This relates to actions 403 and 602 described above. The ENB CONFIGURATION UPDATE message is an already known message, used in existing configuration update procedures. Table 4 depicts a possible new format of an ENB CONFIGURATION UPDATE message, in which some IEs have been added as compared to the ENB CONFIGURATION UPDATE message in 3GPP TS 36.423, Release 12.

TABLE 4
Possible new format of an ENB CONFIGURATION UPDATE message

| | | | IE type | | |
|---|---|---|---|---|---|
| | | | and | Semantics | |
| IE/Group Name | Presence | Range | reference | description | |
| Message Type | M | | 9.2.13 | | |
| Served Cells To | | 0 . . . <maxCellineNB> | | Complete list | |
| Add | | | | of added | |
| | | | | cells served | |
| | | | | by the eNB | |
| >Served Cell | M | | 9.2.8 | | |
| Information | | | | | |
| >Neighbour | | 0 . . . <maxnoofNeighbours> | | | |
| Information | | | | | |
| >>ECGI | M | | ECGI | E-UTRAN | |
| | | | 9.2.14 | Cell Global | |
| | | | | Identifier of | |
| | | | | the | |
| | | | | neighbour | |
| | | | | cell | |
| >>PCI | M | | INTEGER | Physical Cell | |
| | | | (0 . . . 503, . . . ) | Identifier of | |
| | | | | the | |
| | | | | neighbour | |
| | | | | cell | |
| >>EARFCN | M | | 9.2.26 | DL EARFCN | |
| | | | | for FDD or | |
| | | | | EARFCN for | |
| | | | | TDD | |
| >>TAC | O | | OCTET | Tracking | |
| | | | STRING | Area Code | |
| | | | (2) | | |
| Served Cells To | | 0 . . . <maxCellineNB> | | Complete list | |
| Modify | | | | of modified | |
| | | | | cells served | |
| | | | | by the eNB | |
| >Old ECGI | M | | ECGI | Old E- | |
| | | | 9.2.14 | UTRAN Cell | |
| | | | | Global | |
| | | | | Identifier | |
| >Served Cell | M | | 9.2.8 | | |
| Information | | | | | |
| >Neighbour | | 0 . . . <maxnoofNeighbours> | | | |
| Information | | | | | |
| >>ECGI | M | | ECGI | E-UTRAN | |
| | | | 9.2.14 | Cell Global | |
| | | | | Identifier of | |
| | | | | the | |
| | | | | neighbour | |
| | | | | cell | |
| >>PCI | M | | INTEGER | Physical Cell | |
| | | | (0 . . . 503, . . . ) | Identifier of | |
| | | | | the | |
| | | | | neighbour | |
| | | | | cell | |
| >>EARFCN | M | | 9.2.26 | DL EARFCN | |
| | | | | for FDD or | |
| | | | | EARFCN for | |
| | | | | TDD | |
| >>TAC | O | | OCTET | Tracking | |
| | | | STRING | Area Code | |
| | | | (2) | | |
| >Deactivation | O | | ENUMERATED | Indicates that | |
| Indication | | | (deactivated, . . . ) | the | |
| | | | | concerned | |
| | | | | cell is | |
| | | | | switched off | |
| | | | | for energy | |
| | | | | saving | |
| | | | | reasons | |
| Served Cells To | | 0 . . . <maxCellineNB> | | Complete list | New IE |
| Update | | | | of modified | |
| | | | | cells served | |
| | | | | by the eNB | |
| >Served Cell | M | | 9.2.8 | | New IE |
| Information | | | | | |
| >Neighbour | | 0 . . . <maxnoofNeighbours> | | | New IE |
| Information | | | | | |
| >>ECGI | M | | ECGI | E-UTRAN | New IE |
| | | | 9.2.14 | Cell Global | |
| | | | | Identifier of | |
| | | | | the | |
| | | | | neighbour | |
| | | | | cell | |
| >>PCI | M | | INTEGER | Physical Cell | New IE |
| | | | (0 . . . 503, . . . ) | Identifier of | |
| | | | | the | |
| | | | | neighbour | |
| | | | | cell | |
| >>EARFCN | M | | 9.2.26 | DL EARFCN | New IE |
| | | | | for FDD or | |
| | | | | EARFCN for | |
| | | | | TDD | |
| >>TAC | O | | OCTET | Tracking | New IE |
| | | | STRING | Area Code | |
| | | | (2) | | |
| >Deactivation | O | | ENUMERATED | Indicates that | New IE |
| Indication | | | (deactivated, . . . ) | the | |
| | | | | concerned | |
| | | | | cell is | |
| | | | | switched off | |
| | | | | for energy | |
| | | | | saving | |
| | | | | reasons | |
| Served Cells To | | 0 . . . <maxCellineNB> | | Complete list | |
| Delete | | | | of deleted | |
| | | | | cells served | |
| | | | | by the eNB | |
| >Old ECGI | M | | ECGI | Old E- | |
| | | | 9.2.14 | UTRAN Cell | |
| | | | | Global | |
| | | | | Identifier of | |
| | | | | the cell to be | |
| | | | | deleted | |
| GU Group Id To | | 0 . . . <maxPools> | | | |
| Add List | | | | | |
| >GU Group Id | M | | 9.2.20 | | |
| GU Group Id To | | 0 . . . <maxPools> | | | |
| Delete List | | | | | |
| >GU Group Id | M | | 9.2.20 | | |

Table 5 depicts a possible format of a Cell Information Requested IE, which may be comprised in the first message, such as the ENB CONFIGURATION REQUEST message or the ENB CONFIGURATION UPDATE REQUEST message.

TABLE 5
Possible format of a Cell Information Requested information element

| IE/Group | | IE type and | |
|---|---|---|---|
| Name | Presence | reference | Semantics description |
| Cell | M | BIT | Each position in the bitmap |
| Information | | STRING ( ) | represents a set of information: |
| Requested | | | first bit = Served Cell |
| | | | Information, second |
| | | | bit = Neighbour |
| | | | Information, . . . Value |
| | | | ‘1’ indicates ‘information |
| | | | requested’. Value ‘0’ indicates |
| | | | ‘information not requested’. |

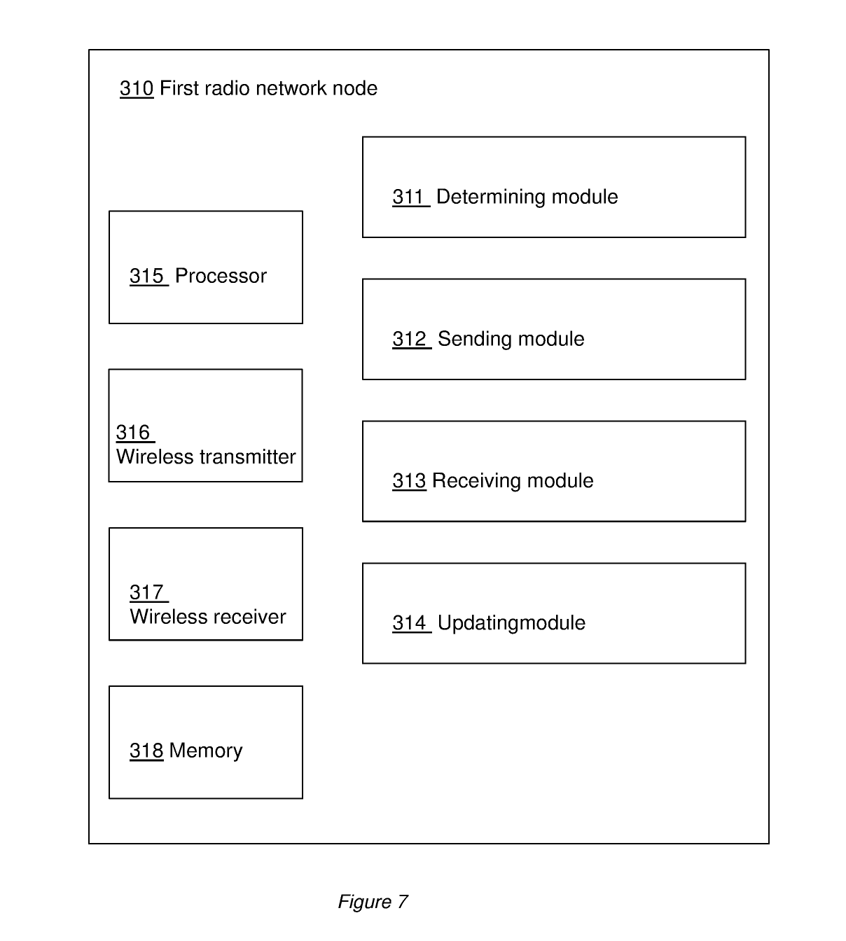

The first radio network node 310 configured to perform the method actions for updating external cell information relating to a first cell 330 served by a second radio network node 320, as described above in relation to FIG. 4, is depicted in FIG. 7.

The first radio network node 310 is configured to determine that there is a need to update the external cell information, e.g. by means of a determining module 311. The determining module 311 may be a processor 315 of the first radio network node 310. In some embodiments the first radio network node 310 is configured to determine that there is a need to update the external cell information, based on a detection of at least one of a Physical Cell Identity, PCI, collision and a PCI confusion. In some embodiments the first radio network node 310 is configured to determine that there is a need to update the external cell information, based on an addition of a relation between a third cell 360 and the first cell 330. The third cell 360 is served by the first radio network node 310.

The first radio network node 310 is further configured to send, e.g. by means of a sending module 312, a first message to the second radio network node 320, which first message comprises a request for data representing information relating to the first cell 330. The sending module 312 may be a wireless transmitter 316 of the first radio network node 310. In some embodiments, the request for data relating to the first cell 330 comprises an indication of a kind of information requested. The kind of information is then at least one of information relating to the first cell 330 and information relating to at least one second cell 340 neighbouring the first cell.

The first radio network node 310 is further configured to receive, e.g. by means of a receiving module 313, a second message, from the second radio network node 320, which second message comprises the requested data. The receiving module 313 may be a wireless receiver 317 of the first radio network node 310.

The first radio network node 310 is further configured to update, e.g. by means of an updating module 314, the external cell information based on the received data. The updating module 314 may be a processor 315 of the first radio network node 310.

The embodiments herein for updating external cell information may be implemented through one or more processors, such as a processor 315 in the first radio network node 310 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the in the first radio network node 310. One such carrier may be in the form of a CD ROM disc. It is however feasible with other data carriers such as a memory stick. The computer program code may furthermore be provided as pure program code on a server and downloaded to the first radio network node 310.

The first radio network node 310 may further comprise a memory 318 comprising one or more memory units. The memory 318 is arranged to be used to store indications, metrics, determined measures of the downlink interference, cell parameters, configurations, and applications to perform the methods herein when being executed in the first radio network node 310.

Those skilled in the art will also appreciate that the determining module 311, sending module 312, receiving module 313, updating module 314, wireless transmitter 316, and wireless receiver 317 described above may refer to a combination of analog and digital circuits, and/or one or more processors configured with software and/or firmware, e.g. stored in a memory, that when executed by the one or more processors such as the processor 315 as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

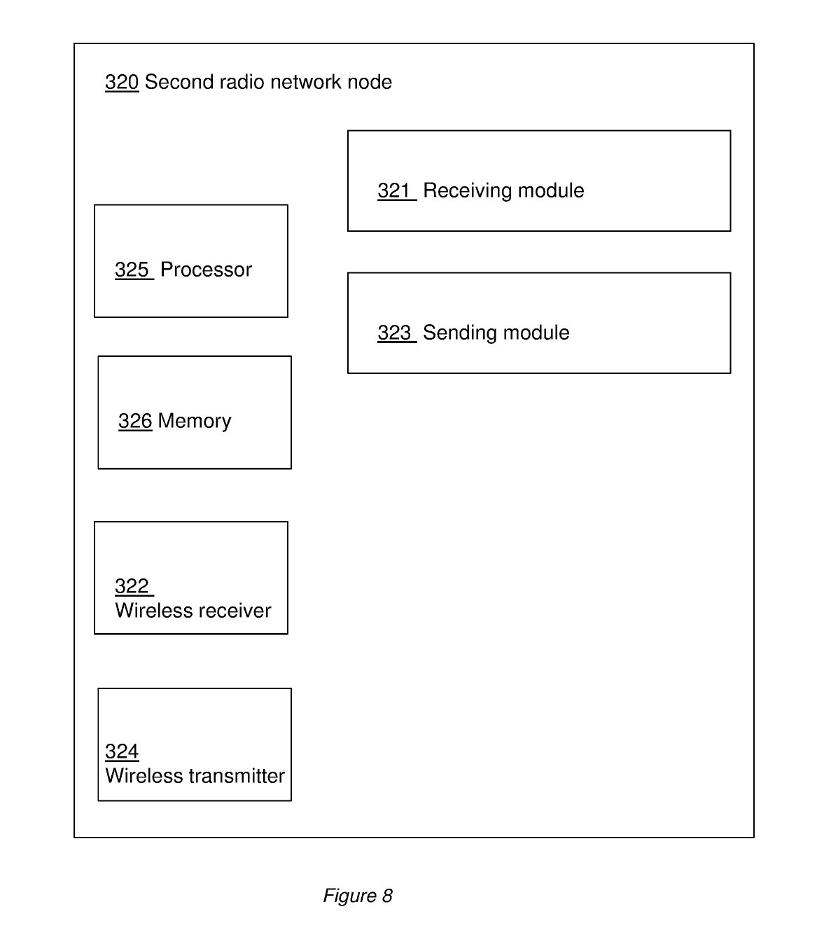

The second radio network node 320 configured to perform the actions for updating external cell information in a first radio network node 310 as described above in relation to FIG. 6, is depicted in FIG. 8. The external cell information relates to a first cell 330 served by the second radio network node 320. The second radio network node is configured to receive, from the first radio network node 310, a first message, e.g. by means of a receiving module 321. The receiving module 321 may be a wireless receiver 322 of the second radio network node 320. The first message comprises a request for data representing information relating to the first cell 330. In some embodiments, the request for data relating to the first cell 330 comprises an indication of a kind of information requested. The kind of information is then at least one of information relating to the first cell 330 and information relating to at least one second cell 340 neighbouring the first cell 330.

The second radio network node 320 is further configured to send, e.g. by means of a sending module 323, a second message to the first radio network node 310, which second message comprises the requested data, for enabling the first radio network node 310 to update the external cell information based on the data. The sending module 323 may be a wireless transmitter 324 of the second radio network node 320.

The embodiments herein for updating external cell information may be implemented through one or more processors, such as a processor 325 in the second radio network node 320 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the in the second radio network node 320. One such carrier may be in the form of a CD ROM disc. It is however feasible with other data carriers such as a memory stick. The computer program code may furthermore be provided as pure program code on a server and downloaded to the second radio network node 320.

The second radio network node 320 may further comprise a memory 326 comprising one or more memory units. The memory 326 is arranged to be used to store indications, metrics, determined measures of the downlink interference, cell parameters, configurations, and applications to perform the methods herein when being executed in the second radio network node 320.

Those skilled in the art will also appreciate that the receiving module 321, sending module 323, wireless receiver 322, and wireless transmitter 324 described above may refer to a combination of analog and digital circuits, and/or one or more processors configured with software and/or firmware, e.g. stored in a memory, that when executed by the one or more processors such as the processor 325 as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1. A method in a first radio network node, for updating external cell information, which external cell information relates to a first cell served by a second radio network node, the method comprising:
determining that there is a need to update the external cell information;
sending, to the second radio network node, a first message which first message comprises a request for data representing information relating to the first cell;
receiving, from the second radio network node, a second message, which second message comprises the requested data; and
updating the external cell information based on the received data.

2. The method according to claim 1, wherein the request for data relating to the first cell comprises an indication of a kind of information requested, the kind of information being at least one of:
information relating to the first cell; and
information relating to at least one second cell neighboring the first cell.

3. The method according to claim 1, wherein the determining is based on a detection of at least one of a Physical Cell Identity, PCI, collision and a PCI confusion.

4. The method according to claim 1, wherein the determining is based on an addition of a relation between a third cell and the first cell, wherein the third cell is served by the first radio network node.

5. A first radio network node, for updating external cell information, which external cell information relates to a first cell served by a second radio network node, the first radio network node being configured to:
determine that there is a need to update the external cell information;
send, to the second radio network node, a first message which first message comprises a request for data representing information relating to the first cell;
receive, from the second radio network node, a second message, which second message comprises the requested data; and
update the external cell information based on the received data.

6. The first radio network node according to claim 5, wherein the request for data relating to the first cell comprises an indication of a kind of information requested, the kind of information being at least one of:
information relating to the first cell; and
information relating to at least one second cell neighboring the first cell.

7. The first radio network node according to claim 5, wherein the first radio network node is configured to determine that there is a need to update the external cell information, based on a detection of at least one of a Physical Cell Identity, PCI, collision and a PCI confusion.

8. The first radio network node according to claim 5, wherein the first radio network node is configured to determine that there is a need to update the external cell information, based on an addition of a relation between a third cell and the first cell, wherein the third cell is served by the first radio network node.

9. A method in a second radio network node, for updating external cell information in a first radio network node, which external cell information relates to a first cell served by the second radio network node, the method comprising:
receiving, from the first radio network node, a first message, which first message comprises a request for data representing information relating to the first cell; and
sending, to the first radio network node, a second message, which second message comprises the requested data, for enabling the first radio network node to update the external cell information based on the data.

10. The method according to claim 9, wherein the request for data relating to the first cell comprises an indication of a kind of information requested, the kind of information being at least one of:
information relating to the first cell; and
information relating to at least one second cell neighbouring neighboring the first cell.

11. A second radio network node, for updating external cell information in a first radio network node, which external cell information relates to a first cell served by the second radio network node, the second radio network node being configured to:
receive, from the first radio network node, a first message, which first message comprises a request for data representing information relating to the first cell; and
send, to the first radio network node, a second message, which second message comprises the requested data, for enabling the first radio network node to update the external cell information based on the data.

12. The second radio network node according to claim 11, wherein the request for data relating to the first cell comprises an indication of a kind of information requested, the kind of information being at least one of:
information relating to the first cell; and
information relating to at least one second cell neighboring the first cell.

13. The method according to claim 2, wherein the determining is based on a detection of at least one of a Physical Cell Identity, PCI, collision and a PCI confusion.

14. The method according to claim 13, wherein the determining is based on an addition of a relation between a third cell and the first cell, wherein the third cell is served by the first radio network node.

15. The method according to claim 2, wherein the determining is based on an addition of a relation between a third cell and the first cell, wherein the third cell is served by the first radio network node.

16. The first radio network node according to claim 6, wherein the first radio network node is configured to determine that there is a need to update the external cell information, based on a detection of at least one of a Physical Cell Identity, PCI, collision and a PCI confusion.

17. The first radio network node according to claim 16, wherein the first radio network node is configured to determine that there is a need to update the external cell information, based on an addition of a relation between a third cell and the first cell, wherein the third cell is served by the first radio network node.

18. The first radio network node according to claim 6, wherein the first radio network node is configured to determine that there is a need to update the external cell information, based on an addition of a relation between a third cell and the first cell, wherein the third cell is served by the first radio network node.
